(19) United States
(12) Patent Application Publication
(10) Pub. No.: US 2014/0133126 A1
(43) Pub. Date: May 15, 2014

(54) ILLUMINANT KEYBOARD DEVICE

(71) Applicant: CHICONY ELECTRONICS CO., LTD., New Taipei City (TW)

(72) Inventor: Ching-Cheng TSAI, New Taipei City (TW)

(73) Assignee: CHICONY ELECTRONICS CO., LTD., New Taipei City (TW)

(21) Appl. No.: 13/673,254

(22) Filed: Nov. 9, 2012

(51) Int. Cl. F21V 11/16

(52) U.S. Cl. CPC F21V 11/16
USPC 362/23.03

(57) ABSTRACT

An illuminant device includes a lighting module, a bottom frame, and a keying unit. The lighting module includes a light guide plate and a light source. The light source has an optical axis. The bottom frame is located under the lighting module and includes a plurality of hook bodies. Each hook body includes a baffling portion and a flange. An extending direction of the baffling portion is substantially parallel to the optical axis, and an extending direction of the flange is substantially perpendicular to the optical axis. The keying unit is located above the lighting unit and includes a first lever and a second lever, the first lever intersects to the second lever, one end of the first lever and one end of the second lever are placed between the bottom frame and the flange and are in contact with a contacting surface of the baffling surface.

### BACKGROUND OF THE INVENTION

1. Field of the Invention

The present invention relates to a keyboard device, and in particular to an illuminant keyboard device.

2. Description of Related Art

Reference is made to FIG. 1, which is a perspective view of a lighting module and bottom frame according to a conventional illuminant keyboard device. The lighting module 50 includes a light source 52 and a light guide plate 54. The light source 52 has an optical axis I and is disposed on a lateral surface 540 of the light guide plate 54. The light source 52 and the light guide plate 54 collectively construct an edge-emitting lighting module for lighting a key unit (not shown) disposed above the lighting module 50. A plurality of through holes 542 are formed on the light guide plate 54, such that light emitted from the light source and inputted into the light guide plate 54 via the lateral surface 540 can be outputted by each hole-wall of each through hole 542, as shown in FIG. 2.

The bottom frame 60 is disposed at bottom of the light guide plate 50 and a plurality of hook bodies 62 are formed on the bottom frame 60 by stamping. Each hook body 62 includes a baffling portion 620 and a flange 622 extending outwardly from a top edge of the baffling portion 620. An extending direction of the baffling portion and an extending direction of the flange 622 are substantially perpendicular to the optical axial I of the light source 52. The flange 622 is pivoted to the keying unit disposed above the lighting module 50, such that the keying unit can move upward or downward corresponding to the bottom frame 60.

Each baffling portion 620 is of rectangular shape. Each baffling portion 620 has a face 621 and a contacting surface 624 used for fasten the keying unit. The face 621 is a surface with relative larger area, (namely, the area of the face 621 is lager then that of the contacting surface 624) and has a normal n parallel to the optical axis I of the light source 52.

Referring to FIG. 2 and FIG. 3, the light emitted from the lighting source 52 is inputted into the light guide plate 54 via the lateral surface 540, transmitted within the light guide plate 54 and then outputted from the top surface of the light guide plate 54. The extending direction of the baffling portion 620 and the flange 622 is perpendicular to the optical axis I of the light source 52, this causes most light outputted from the hole-walls is blocked by the face 621, and largely decreases light transmitting efficiency.

### SUMMARY OF THE INVENTION

It is an object to provide an illuminant keyboard device.

Accordingly, an illuminant device comprises a lighting module, a bottom frame, and at least a keying unit is provided. The lighting module comprises a light guide plate and at least a light source. The light guide plate comprises a light-incident surface and a plurality of through-holes. The light source having an optical axis is disposed on the light-incident surface. The bottom frame is located under the lighting module and comprises a plurality of hook bodies. Each hook body comprises a baffling portion and a flange. An extending direction of the baffling portion is substantially parallel to the optical axis. The baffling portion includes a contacting surface with relative large area, a normal of the contacting surface is substantially perpendicular to the optical axis. An extending direction of the flange is substantially perpendicular to the optical axis of the lighting source. The keying unit is located above the lighting unit and comprises a keycap, a first lever, and a second lever, the first lever intersects to the second lever, one end of the first lever and one end of the second lever couple to the keycap, and the other end of the first lever and the other end of the second lever are placed between the bottom frame and the flange and are in contact with the contacting surface.

In the present invention, the extending direction of each baffling portion of each hook body is substantially parallel to the optical axis of the light source. Therefore, the light-transmitting efficiency can be increased even if the disposing direction of the keycap is still the same as conventional keycap.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of a lighting module and a bottom frame according to a conventional illuminant keyboard device.

FIG. 2 is a partially sectional view of the lighting module and the bottom frame according to the conventional illuminant keyboard device and shows light transmitting route thereof.

FIG. 3 is a top view of the lighting module and the bottom frame according to the conventional illuminant keyboard device.

FIG. 4 is a perspective view of an illuminant keyboard device according to the present invention.

FIG. 5 is an assemble view of the illuminant device according to the present invention.

FIG. 6 is a top view of a lighting module and a bottom frame of the illuminant device according to the present invention.

FIG. 7 is a partially sectional view of the lighting module and the bottom frame and shows light transmitting route according to the present invention.

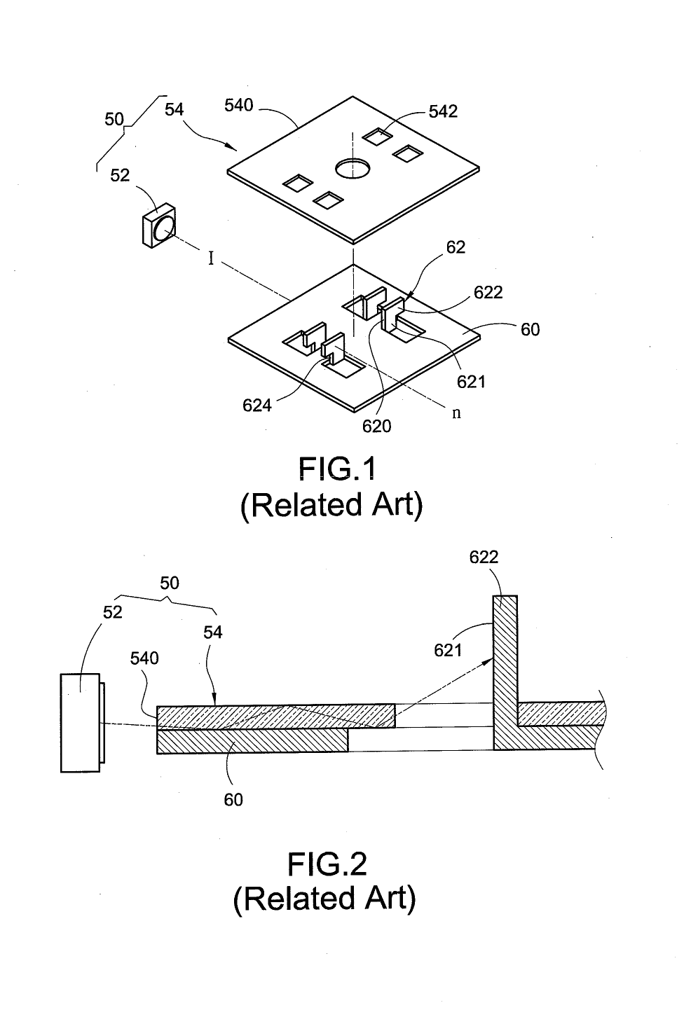

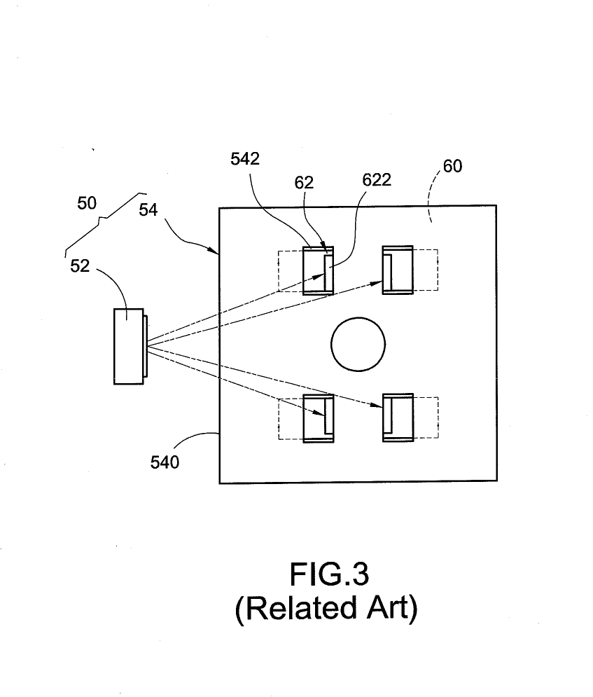

### DETAILED DESCRIPTION OF THE INVENTION

A preferred embodiment of the present invention will be described with reference to the drawings.

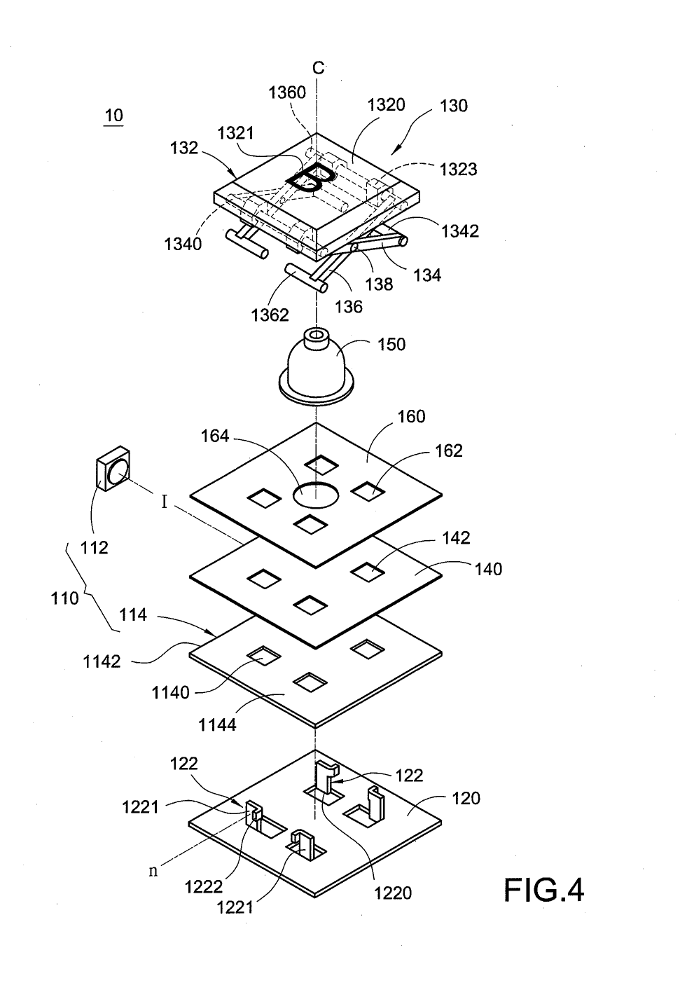

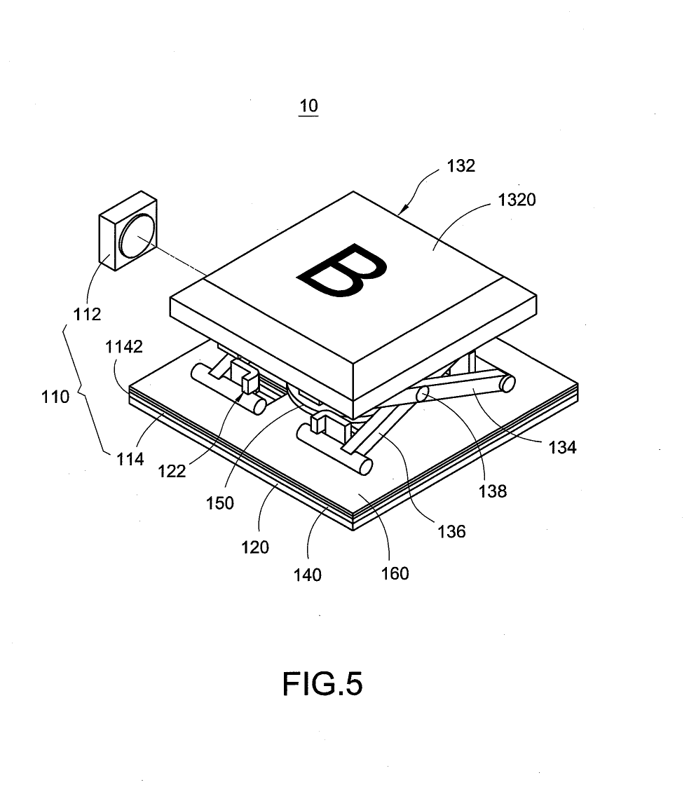

Referring to FIG. 4 and FIG. 5, FIG. 4 is a perspective view of an illuminant keyboard device according to the present invention, and FIG. 5 is an assemble view of the illuminant keyboard device according to the present invention. The illuminant keyboard device 10 includes a lighting module 110, a bottom frame 120, and a keying unit 130.

The lighting module 110 is an edge-emitting lighting module and is used for lighting the keying unit 130. The lighting module 110 includes a light source 112 and a light guide plate 114. The light source 112 has an optical axis I, which is a central axis of light beam emitted from the light source 112. The light source 112 is light emitting diode (LED), fluorescent tube or compact lamp, and the amount of the light source 112 may be one or more. In this embodiment, the lighting module 110 includes, for example, one light source 112, and the light source 112 is preferably LED.

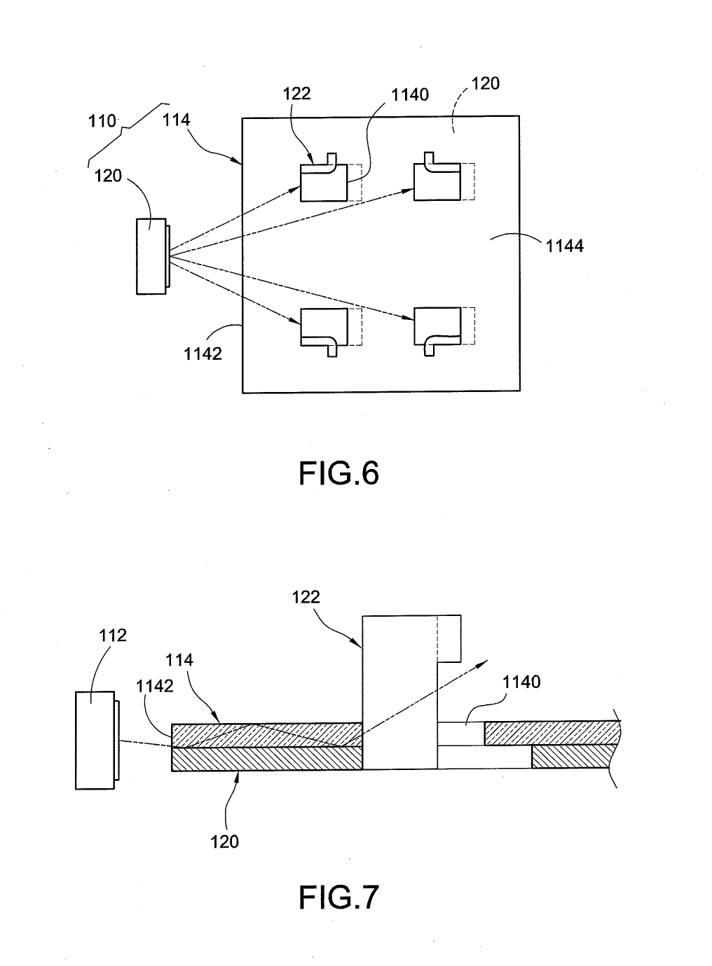

The light guide plate 114, which is a light-previous body, is used for guiding light inputted therein. A plurality of through holes 1140 are formed on the light guide plate 114. In this embodiment, the light guide plate 114 includes four through holes 1140. The light source 112 is disposed on a light-incident surface 1142 of the light guide plate 114, and emitting light toward the light-incident surface 1142, as shown in FIG. 6. The light guide plate 114 and the light source 112 collectively construct an edge-emitting lighting module.

The bottom frame 120 is located under the light module 110. The bottom frame 120 is preferably a metallic plate, which has effect of light-reflection for reflecting light leaked from lighting module 110 and then improving the utilization efficiency of light. The bottom frame 120 includes a plurality of hook bodies 122 protruded upward therefrom, and the forming step of hook bodies 122 is preferably, but not limited to, accomplished using stamping process. The amount of the hook bodies 122 is the same as that of the through-holes 1120. In this embodiment, the bottom frame 120 includes four hook bodies 122, and the hook bodies 122 penetrate the through-holes 1140, respectively.

Each hook body 122 includes a baffling portion 1220, and an extending direction of the baffling portion 1220 is substantially parallel to the optical axis I. The baffling portion 1220 is of rectangular shape and includes a contacting surface 1221. The contacting surface 1221 is a surface with relative large area. A normal n of the contacting surface 1221 is substantially perpendicular to the optical axis I of the lighting source 112.

Each hook body 122 further includes a flange 1222. The flange 1222 is formed on a top end of the baffling portion 1220, and an extending direction of the flange 1222 is substantially perpendicular to the optical axis I of the light source 112. In this embodiment, the flanges 1222 are respectively formed on the top ends of the baffling portion 1220 which is close to where the central axis C is disposed, and each flange 1222 is extending to a direction which is far away from where the central axis C is disposed. In addition, the volume of each flange 1222 is smaller than that of each baffling portion 1220.

The keying unit 130 is located above the lighting unit 110 and includes a keycap 132, a first lever 134, and a second lever 136. The keycap 132 is substantially of rectangular shape and includes a pressing surface 1320 and an assembling surface (not shown). The pressing surface 1320 can be pressed by user and at least a letter 1321 is disposed thereon for identifying the keycap 132. The keycap 132 may be made by optical-transparent material for allowing light travel from the assembling surface to the pressing surface 1320 and lighting the letter 1321. However, the optical-transparent material may be disposed only on an area which is corresponding to where the letter 1321 is disposed. A plurality of engaging members 1323 are formed on the assembling surface. In this embodiment, the assembling surface is, for example, includes four engaging members 1323.

The first lever 134 and the second lever 136 intersect in the shape of X and coupled with each other at a intersection, a pivot 138 pivots at the intersection of the first lever 134 and the second lever 136. One end of the first lever 134 has a first connecting stick 1340, and the other end of the first lever 134 has at least a first positioning stick 1342. One end of the second lever 136 has a second connecting stick 1360, and the other end of the second lever 136 has at least second positioning stick 1342. The first connecting stick 1340 and the second connecting stick 1360 are coupled to the engaging members 1323, respectively. In this embodiment, the first lever 134 includes two first positioning sticks 1342, and the second lever 136 includes two second positioning sticks 1362. Each first positioning stick 1342 and each second positioning stick 1362 is disposed between the bottom frame 120 and each flange 1222 and in contact with the contacting surface 1221, such that the keycap 132 is movably supported on the first lever 134 and the second lever 136 and moving upward or downward corresponding to the bottom frame 120.

Referring to FIG. 6 and FIG. 7, FIG. 6 is a top view of the lighting module and the bottom frame of the illuminant device according to the present invention, and FIG. 7 is a partially sectional view of the lighting module and the bottom frame and shows light transmitting route according to the present invention. The light emitted from the lighting source 112 is inputted to the light guide plate 114 via the light-incident surface 1142, and then the light is transmitted in the light guide plate 114. As the result of that the extending direction of the baffling portion 1220 is substantially parallel to the optical axis I of the light source 112, the probability of light blocked by the contacting surface 1221 is reduced, and most light can be transmitted to one end of the light guide plate 114 away from the light source 112.

With reference again to FIG. 4 and FIG. 5, the illuminant keyboard device 10 further includes a circuit board 140, an elastic member 150 and a light-shielding plate 160. The circuit board 140 is disposed on the light guide plate 114, and is used for detecting whether the keycap 132 is depressing or not, and triggers an inputting signal corresponding to the depressed keycap 132. The circuit board 140 may be membrane circuit board or other circuit boards, and a plurality of openings 142 corresponding to the hook bodies 122 are formed thereon for the hook bodies 122 penetrating therethrough. In this embodiment, the circuit board 140 includes, for example, four openings 142.

The elastic member 150 is placed under the keycap 132 and providing urging force to elastically press up the keycap 132. The elastic member 150 may be rubber dome or other elastic body. The elastic member 150 may be directly formed on the circuit board 140, or fastened on the circuit board 140 through an adhesive (not shown).

The light-shielding plate 160 is disposed on the circuit board 140. The light-shielding plate 160 has a plurality of via-holes 162 formed thereon, and the via-holes 162 are used for the hook bodies 122 penetrating therethrough. The light-shielding plate 160 further includes a plurality of vents 164 formed thereon and corresponding to the elastic members 150. The vents 164 are used for the elastic member 150 to touch the circuit board 140 and then trigger an inputting signal. In this embodiment, the light-shielding plate 160 includes, for example, four via-holes 162. The light-shielding plate 160 may be made of metal, plastic or other opaque materials to prevent light directly projected to the keycap 132 via the circuit board 140, so as to prevent light travelling to the keycap 132 via the circuit board 140, directly, to form interference light, and then influence user to recognize the letter 1321 of the keycap 132.

To sum up, in the present invention, the extending direction of each baffling portion 1220 of each hook body 122 is substantially parallel to the optical axis I of the light source. Therefore, the light-transmitting efficiency can be increased even if the disposing direction of the keycap 132 is still the same as conventional keycap.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An illuminant device comprising:
a lighting module comprising a light guide plate and at least a light source, the light guide plate comprising a light-incident surface and a plurality of through-holes, the light source having an optical axis and disposed on the light-incident surface;
a bottom frame located under the lighting module and comprising a plurality of hook bodies, each hook body comprising a baffling portion and a flange, an extending direction of the baffling portion substantially parallel to the optical axis and the baffling portion comprising a contacting surface with relative large area, a normal of the contacting surface substantially perpendicular to the optical axis, an extending direction of the flange substantially perpendicular to the optical axis of the lighting source; and
at least a keying unit located above the lighting unit and comprising a keycap, a first lever, and a second lever, the first lever intersecting to the second lever, one end of the first lever and one end of the second lever coupling to the keycap, and the other end of the first lever and the other end of the second lever placed between the bottom frame and the flange and being in contact with the contacting surface.

2. The illuminant keyboard device in claim 1, wherein one end of the first lever comprises at least a first positioning stick, and one end of the second lever comprises at least a second positioning stick, the first positioning stick and the second positioning stick are respectively placed between the bottom frame and the flange, and are respectively in contact with the contacting surface.

3. The illuminant keyboard device in claim 1, further comprising a circuit board disposed on the lighting module, the circuit board comprises a plurality of openings corresponding to the hook bodies, and the hook bodies penetrate through the openings.

4. The illuminant keyboard device in claim 3, further comprising an elastic member located under the keycap and providing urging force to elastically press up the keycap.

5. The illuminant keyboard device in claim 3, further comprising a light-shielding plate disposed on the circuit board, the light-shielding plate comprises a plurality of via-holes corresponding to the hook bodies, the hook bodies penetrate the via-holes, the light-shielding plate further comprises a vent corresponding to the elastic member, the elastic member touches the circuit board for triggering an inputting signal via the vent.

6. The illuminant keyboard device in claim 1, wherein the keying unit further comprises a pivot pivoting at an intersection of the first lever and the second lever.

7. The illuminant keyboard device in claim 2, wherein an assembling surface of the keycap comprises a plurality of engaging members, at least one first connecting stick is placed at one end of the first lever opposite to the first positioning stick, at least one second connecting stick is placed at one end of the second lever and opposite to the second positioning stick, and the first connecting stick and the second stick are coupled to the engaging members, respectively.

8. The illuminant keyboard device in claim 1, the light module is edge-emitting lighting module.

9. The illuminant keyboard device in claim 1, wherein the light source is light emitting diode.
